(19) United States
(12) Patent Application Publication
(10) Pub. No.: US 2003/0079118 A1
(43) Pub. Date: Apr. 24, 2003

(54) Bit synchronous engine and method

(76) Inventor: Felix Chow, San Jose, CA (US)

Correspondence Address: MORRISON & FOERSTER LLP, 3811 VALLEY CENTRE DRIVE, SUITE 500, SAN DIEGO, CA, 92130-2332, US

(21) Appl. No.: 10/046,566

(22) Filed: Oct. 19, 2001

(51) Int. Cl. G06F 7/24

(52) U.S. Cl. 712/300; 712/225

(57) ABSTRACT

A bit-synchronous HDLC engine that processes data in parallel, during a single clock cycle is provided. The HDLC engine of the invention is significantly faster than previous bit-synchronous HDLC engines and, thus, is capable of handling greater bandwidths.

### BACKGROUND OF THE INVENTION

1. Field of the Invention

The invention relates to processing data transmitted and received in digital data networks and, more particularly, to a bit-synchronous data processing engine that processes multiple bits in a single cycle.

2. Description of Related Art

With the ever-increasing bandwidths of digital signals being provided by digital data networks today, the required speed and power of processors to handle these high-bandwidth data streams has been a constant challenge to processor designers and engineers. For example, conventional optical networks such as Synchronous Optical Networks (SONET) can transmit data at bandwidths of 9.953 Gbps or greater! One of the primary limitations for handling higher bandwidth data streams is the ability of the processors to handle such enormous quantities of data. Therefore, there is a constant need to provide faster and more powerful processing engines to handle the higher-bandwidth signals capable of being transmitted in digital networks today.

Bit-synchronous High-level Data Link Control (HDLC) is one of the many types of data transmission protocols used in digital data networks today. This protocol is well-known in the art and, hence, need not be described in detail herein. Conventional bit-synchronous HDLC engines are typically bit-serial (designed to process one bit at a time) due to the bit-oriented nature of bit-synchronous HDLC processing. Therefore, prior art bit-synchronous HDLC engines typically require eight clock cycles to process eight bits (i.e., one byte) of data. Alternatively, other methods and systems attempt to utilize eight bit-serial HDLC engines connected in series to process one byte per cycle. However, the timing path going through eight engines in serial is long and difficult to fit into one clock cycle. Thus, one problem associated with conventional bit-serial engines is that they cannot handle multiple bits in one clock cycle. Additionally, timing problems are commonly encountered when multiple serial engines are utilized.

Therefore, there is a need for a bit-synchronous HDLC engine that can process multiple bits in parallel in a single clock cycle.

### SUMMARY OF THE INVENTION

The invention addresses the above and other needs by providing a bit synchronous HDLC engine designed to perform HDLC processing on multiple bits (e.g., 8 bits) in parallel and in one clock cycle. In one embodiment, a single bit-synchronous HDLC engine is utilized to perform parallel processing on multiple bits during a single clock cycle. By implementing the methods of the invention disclosed herein, this single engine can handle data traffic for higher bandwidth operations when compared to previously known bit-serial engines.

In another embodiment, a bit-synchronous engine is designed to perform HDLC processing on eight incoming bits (i.e., one byte) in parallel in a single clock cycle. The incoming byte together with a previously received byte are stored in a 16-bit shift register for processing. The engine performs the following processing in parallel:

HDLC de-framing (search for a 0×7e HDLC framing flag within the two-byte shift register) to send valid payload information to a cyclic redundancy check (CRC) engine downstream.

Detect an ABORT flag (sequence of seven 1's) and send the appropriate status downstream.

Perform bit “de-stuffing” by stripping out the ‘0’ bit whenever five 1's followed by a ‘0’ is detected.

In a preferred embodiment, the bit-synchronous HDLC engine processes multiple bits in parallel, in a single clock cycle, to detect start-of-frame (SOF) flags, end-of-frame (EOF) flags, ABORT flags, and/or “stuff” bits, for example, to perform the above-mentioned functions. Whereas conventional bit-serial engines typically require multiple state changes (hence multiple cycles) to perform these de-framing, de-stuffing and abort-hunting functions, the parallel processing provided by the invention enables bit-synchronous HDLC de-framing, bit de-stuffing and the hunt for ABORT flag operations in a single clock cycle.

### BRIEF DESCRIPTION OF THE DRAWINGS

FIG. 1 illustrates a block diagram of a bit-synchronous HDLC subsystem having a bit-synchronous HDLC engine, in accordance with one embodiment of the invention.

FIG. 2 illustrates a block diagram of some of the components or subsystems of the bit-synchronous HDLC engine of FIG. 1, in accordance with one embodiment of the invention.

FIG. 3 illustrates a sixteen-bit shift register coupled to multiple eight-bit comparators for simultaneous processing multiple bits in parallel, in accordance with one embodiment of the invention.

FIG. 4 illustrates a flow chart diagram of a method of processing multiple bits in parallel in connection with a bit-synchronous HDLC processing protocol, in accordance with one embodiment of the invention.

### DETAILED DESCRIPTION OF THE PREFERRED EMBODIMENTS

A presently preferred embodiment of the invention is described in detail below with reference to the figures. Although the embodiment involves bit-synchronous HDLC processing, it is readily apparent to those of ordinary skill in the art that the invention can be advantageously utilized, without undue experimentation, in connection with other bit-synchronous data processing protocols that may be presently known or become known in the future, in accordance with the principles of the invention disclosed herein.

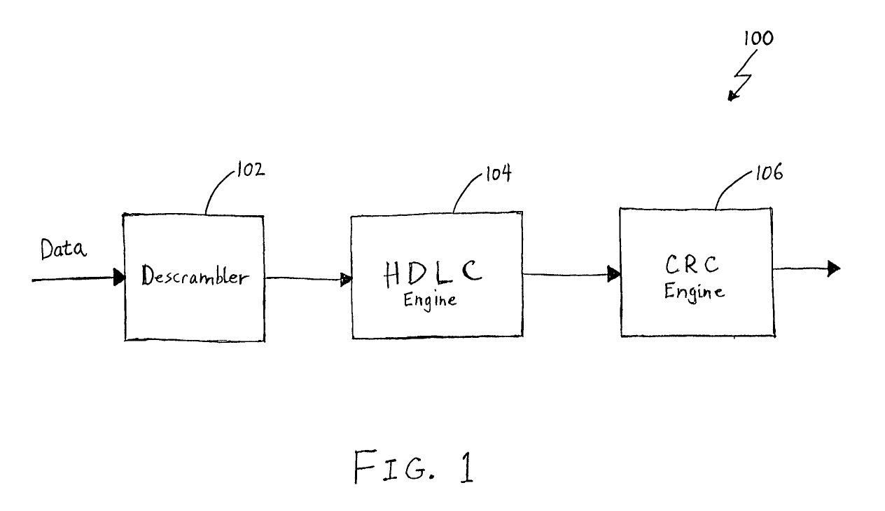

FIG. 1 shows a block diagram of a bit-synchronous HDLC subsystem 100 having a de-scrambler unit 102, an HDLC engine 104 and a CRC engine 106, in accordance with one embodiment of the invention.

The de-scrambler unit 102 is only necessary if the HDLC subsystem 100 is designed to handle scrambled incoming data. If the incoming data is not scrambled, the de-scrambler unit 102 is unnecessary and may be bypassed. In one embodiment, the de-scrambler unit 102 may be any conventional de-scrambler known in the art for de-scrambling incoming data which has been scrambled prior to transmission across a data line for security purposes, for example. In one exemplary embodiment, the de-scrambler unit 102 performs ATM type de-scrambling which incorporates a 43-bit shift register with a specified bit (e.g., bit 0, the “oldest” bit in the register) XORed with the incoming bit. In a preferred embodiment, the de-scrambler unit 102 performs the de-scrambling on an incoming eight bits in parallel and, hence, the latency for de-scrambling eight bits (i.e., one byte) is one cycle.

In another embodiment, the de-scrambler unit 102 incorporates a Larscom-type de-scrambler (e.g., Access-T45 model), developed by Larscom, Inc., Milpitas, Calif., in which the polynomial used is Xˆ 20+Xˆ 17+1=0. Other types of de-scramblers that may be supported include, for example, Digital Link de-scramblers, manufactured by Quick Eagle Networks, Sunnyvale, Calif., and Kentrox de-scramblers, manufactured by Kentrox, LLC, Hillsboro, Oreg. These latter two types of de-scramblers utilize the polynomial Xˆ 43+1. Regardless of the de-scrambling formula that is utilized, in a preferred embodiment, the de-scrambler unit 102 de-scrambles eight incoming bits in parallel, in one clock cycle. The de-scrambler unit 102 then passes the data to the bit-synchronous HDLC engine 104 for further processing.

In a preferred embodiment, the bit-synchronous HDLC engine 104 performs the following basic functions:

1. Detect SOF and EOF flags to perform HDLC de-framing and to pass along valid payload information to the CRC engine 106.

2. Detect the ABORT flag (sequence of seven 1's).

3. Perform bit “de-stuffing” by stripping out the ‘0’ bit whenever five 1's followed by a ‘0’ is detected.

As known in the art, a SOF and EOF flag sequence indicates the beginning and end of a frame, respectively, and is used for frame synchronization. To detect a SOF or EOF flag, the bit stream is examined for the binary sequence of six consecutive ones preceded and followed by a zero (i.e., 01111110=hexadecimal 0×7e).

An Abort sequence typically consists of a string of more than six “1” bits. This Abort sequence indicates an invalid frame, which is ignored, and not counted as a Frame Check Sequence (FCS) error.

“Bit-stuffing” is performed as necessary on the payload data. At the transmitter end, the transmitter examines the entire frame between two flag sequences. A “0” bit is inserted after all sequences of five contiguous “1” bits (including the last 5 bits of the FCS) to ensure that a SOF/EOF flag sequence is not simulated. Bit de-stuffing is performed at the receiving end where any “0” bit that directly follows five contiguous “1” bits is discarded as a “stuff” bit.

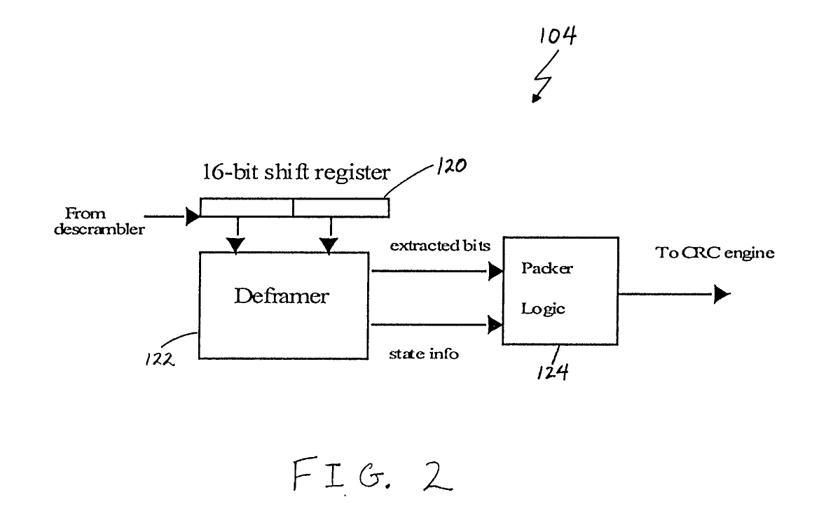

As explained in further detail below with respect to FIG. 2, the HDLC engine further generates status information pertaining to the incoming data for each channel such as whether a SOF or EOF flag has been detected, whether an Abort sequence has been detected, whether the packet is a “short packet,” etc.

FIG. 2 illustrates a block diagram of some of the components/subsystems of the bit-synchronous HDLC engine 104, in accordance with one embodiment of the invention. The HDLC engine 104 includes a sixteen-bit shift register 120 which shifts in and stores eight incoming bits (e.g., one byte) at each clock cycle. The HDLC engine 104 further includes a de-framer unit 122 that processes, in parallel, the data stored in the sixteen-bit window 120 formed by the current and the previous byte. In this way, the de-framer unit 122 can detect a specified sequence (e.g., SOF, EOF, Abort, stuff bit, etc.) within the two-byte window 120 in a single clock cycle and, thereafter, pass along valid payload data and state information to a packer logic unit 124. The packer logic unit 124 receives and stores payload data which has been “de-stuffed” and upon receiving a byte of data from a data channel, it sends this packet to a CRC engine 106 (FIG. 1) for further processing. In one embodiment, if a packet does not meet minimum length requirements (e.g., at least N bytes long), it is designated as a “short packet” by the packer logic unit 124 and later discarded downstream. The packer logic unit 124 tags the final byte with a “short packet” flag such that a processing unit downstream, typically after the CRC engine 106, can discard all the bytes associated with that short packet. In one embodiment, N=4. The CRC engine 106 may be any conventional CRC engine known in the art.

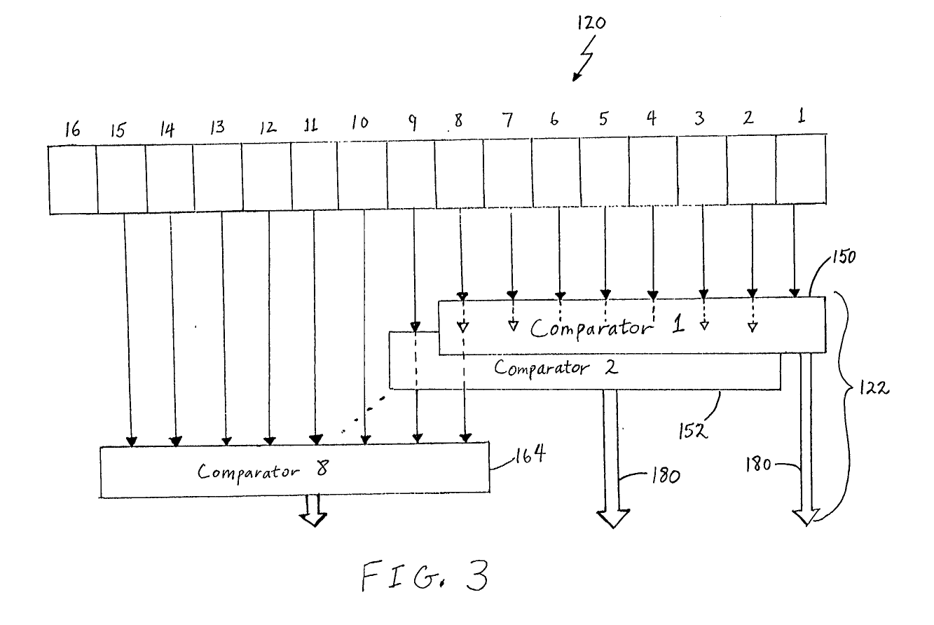

Referring to FIG. 3, a sixteen-bit shift register 120 comprises sixteen bit positions, labeled 1-16 for illustrative purposes only. Specified bit sequences (e.g., SOF flag, EOF flag, Abort flag, stuff bit) are identified by a plurality of comparators 150-164 coupled to the sixteen-bit shift register 120, in accordance with one embodiment of the invention. As shown in FIG. 3, each of eight comparators 150-164 is coupled to a unique subset of eight adjacent bits, each subset being shifted one bit from its adjacent subsets. The comparators 150-164 parallel process the bits in shift register 120 by searching for the specified sequences within the two-byte window 120 during a single clock cycle. Thus, in any given clock cycle, any of the subsets of eight bits within the sixteen-bit window can be identified as a specified sequence. The comparators 150-164 contain logic circuitry for detecting the specified sequences. Such comparators are well-known in the art and, therefore, need not be further described herein.

For detecting SOF and EOF sequences, the comparators 150-164 parallel process all the bits within the shift register 120 by implementing well-known logic functions to detect the sequences during a single clock cycle. For example, if a byte comprising bits 2-9 is identified as a SOF flag sequence by the second comparator 152, the comparator 152 sends a sequence detection signal 180 to de-framing logic circuitry within the de-framer unit 122 indicating that a SOF flag has been detected. The de-framing logic circuitry then determines an offset value to identify valid payload data received after or following the SOF flag. For example, by determining this offset, the de-framer unit 122 knows that in the next cycle, when a new byte has been shifted into the sixteen-bit shift register 120, new bits 2-9 in the shift-register will be valid payload data, unless it is identified as another specified sequence (e.g., EOF flag, Abort flag, or stuff bit).

Similarly, for Abort detection, the comparators 150-164 parallel process all the bits within the shift register 120 by implementing well-known logic functions to detect the Abort sequence during a single clock cycle. If an Abort sequence is detected by one of the comparators 150-164, a sequence detection signal 180, indicating the detection of the Abort sequence, is sent to the de-framing logic circuitry within the de-framer unit 122, causing the de-framer unit 122 to initiate an EOF flag to be sent to the packer logic unit 124 down stream. Any subsequent data is ignored until the next SOF flag sequence is found.

For detecting stuff bits, the comparators 150-164 parallel process all the bits within the shift register 120 by implementing well-known logic functions to detect one or more stuff bits during a single clock cycle. If a stuff bit sequence is detected by one of the comparators 150-164, the de-framing logic circuitry within the de-framer unit 122 disregards the stuff bits (e.g., 0's), and only passes along the valid payload data to the packer logic unit 124.

In a preferred embodiment, each of the comparators 150-164 search for a SOF flag in its respective eight-bit window during each clock cycle. After a SOF flag is detected, each comparator 150-164 simultaneously searches for an EOF flag, an Abort flag and stuff bits during each subsequent clock cycle until an EOF or Abort flag is detected. The logic circuitry within the comparators 150-164 and de-framing logic circuitry described above may be implemented in numerous ways readily known to those of ordinary skill in the art. Additionally, the sequence detection signal 180 may be the specified sequences themselves or any sequence code for indicating that a specified sequence (e.g., SOF, EOF, Abort, stuff bit, etc.) has been detected at a particular location within the two-byte shift register 120. In one embodiment, the logic circuitry of the comparators 150-164 may be integrated with the de-framing logic circuitry so as to create a single integrated circuit. Such circuits, and various modifications thereof, are easily designed and implemented by one of ordinary skill in the art, without undue experimentation. Therefore, a detailed description of the logic circuitry within the comparators 150-164 and/or de-framer unit 122 is not provided herein.

In one embodiment, for bit de-stuffing, the comparators 150-164 search in parallel for a sequence of five “1's” followed by a “0.” In any single sequence of eight bits there are a limited number of combinations in which one to two stuff bits may be present. A single stuff bit may be present at any one of the eight bit locations within a byte. There are three instances when a byte might have two stuff bits. These instances are: “00111110,” “10111110” and “01111101.” In each of these instances, whether the right-most “0” is a stuff bit depends on whether the left-most four to five bits of the previous byte were all “1's,” where bytes are received and shifted into the sixteen-bit shift register 120 from left to right. In one embodiment, the de-framer unit 122 implements de-stuffing logic that assigns a value to a “de-stuff variable,” depending on the bit position(s) of the stuff bits. For example, if a single stuff bit is located at the “bit 1” position, the “de-stuff variable”0 may be assigned a value of one. Similarly, if a single stuff bit is located at the “bit 8” position, the variable may be assigned a value of eight. As a further example, if a byte contains two stuff bits at the “bit 1” and “bit 7” locations (e.g., “00111110”), then the variable may be assigned a value of nine, etc. Various implementations of the de-stuffing logic, in accordance with the present invention, would be readily apparent to and easily implemented by those of ordinary skill in the art.

Each of the possible combinations of one to two stuff bits within a single byte may be represented in a look-up table (LUT) (not shown) within the de-framer unit 122. In one embodiment, LUT's may be implemented, for example, by an array or cascade of multiplexers and/or demultiplexers to represent various states and perform specified operations depending on a current state of its input(s). Such LUT's are well-known in the art and need not be further described in detail herein. In one embodiment, in accordance with the value of the de-stuff variable, the LUT passes through valid payload bits while not allowing stuff bits to pass through to the packer logic unit 124. In one embodiment, the setting of the de-stuff variable and the passing along of valid payload bits, while discarding stuff bits, occurs in real time in a single clock cycle.

Referring again to FIG. 2, the packer logic unit 124 receives valid payload bits from the de-framer unit 122 and packs the extracted bits into a “byte-size” portion (e.g., eight bits) of data before passing the data to the CRC engine 106. In order to determine when a “bytes worth” of data has been received, the packer logic unit 124 adjusts a write pointer and passes along a byte of data when the write pointer value becomes equal to or greater than eight. The packer logic unit 124 keeps track of the number of payload bytes of a frame or packet that have been sent to the CRC engine 106. Packets which are not at least N bytes in length, are designated as “short packets” by the packer logic unit 124 and later discarded downstream. In one embodiment, a state machine (not shown) in the packer logic unit 124 determines when to send valid data out, looks for short packets and drops bytes when an Abort is asserted. The latency of the de-framer unit 122 and packer logic unit 124 is one clock cycle. Therefore, the method and system of the invention can pipeline the de-scrambler, de-framing and CRC operations such that in a single clock cycle, up to three bytes of data may be simultaneously processed by the decrambler unit 102, HDLC engine 104 and the CRC engine 106, respectively.

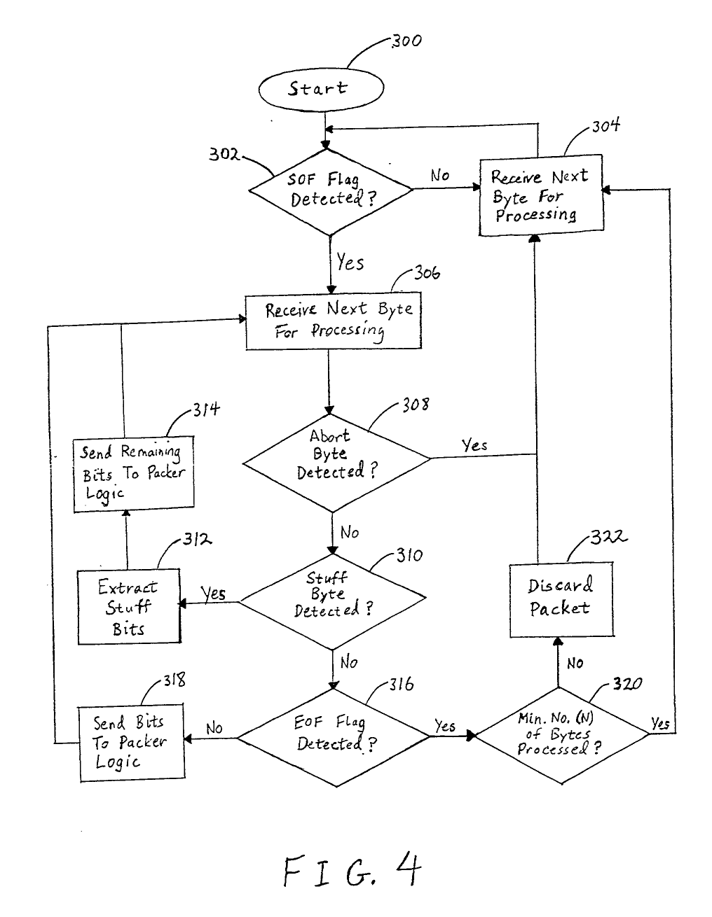

FIG. 4 illustrates a flow chart diagram showing some steps of an eight-bit, parallel, bit-synchronous HDLC processing algorithm, in accordance with one embodiment of the invention. The process begins at step 300 where the initial default setting of the algorithm is the Abort mode wherein all incoming data is discarded. At step 302, as each new incoming byte is shifted into the sixteen-bit shift register 120 (FIG. 2), the process determines whether a SOF flag has been detected within the two-byte window, in accordance with the methods and techniques described above. If no SOF flag is detected, then at step 304, the process receives the next byte of data into the shift register 120 for processing and continues to search for a SOF flag at step 302. If at step 302, a SOF flag is detected, at step 306 a new incoming byte is shifted into the shift register 120 for processing. At step 308, the process begins the determination of whether the SOF flag is followed by valid payload data by determining whether an Abort sequence has been detected within the two-byte window in the next clock cycle. If an Abort sequence has been detected, the process returns to step 304 as described above.

If at step 308, an Abort sequence is not detected, the process proceeds to step 310 to determine if a stuff bit sequence (also referred to herein as a “stuff byte”) has been detected in the two-byte window during the same clock cycle. If a stuff byte is detected, then at step 312, the process “extracts” any stuff bits from the next byte of data to be sent to the packer logic unit 124 (FIG. 2). At step 314, the process sends any remaining bits of the byte to the packer logic unit 124. Recall that the incoming data is shifted into the shift register 120 eight bits (one byte) per clock cycle regardless of the type of data it contains. Therefore, data must be shifted out of the shift register 120 eight bits at a time regardless of what type of data it is. However, some or all of these bits may not be valid payload data. For example, some of these bits may be flag bits, or stuffed bits, which will be discarded by the de-framer 122. Thus, in any give cycle, the packer logic unit 124 may receive anywhere between zero to eight valid payload bytes from the de-framer unit 122.

If at step 310, a stuff byte is not detected, the process proceeds to step 316 where it determines whether an EOF flag has been detected. If at step 316, an EOF flag has not been detected, then at step 318, valid payload bits within the current byte being processed (i.e., the oldest or right-most byte in the two-byte shift register 120) are sent to the packer logic unit 124. The process then returns to step 306 where a new byte of data is shifted into the shift register 120 for processing.

If at step 316, an EOF flag is detected, the process proceeds to step 320 to determine whether a minimum number (N) of bytes have been received. If no, then at step 322, the packet is designated as a “short packet” and all the bytes for that packet are ultimately discarded downstream. If at least the minimum number (N) of payload bytes for a packet or frame have been received by the packer logic unit 124, then those bytes are not designated to be discarded by a downstream unit. The process returns to step 304 to begin processing the next packet or frame of payload data.

As described above, the invention provides a novel method and system for efficiently processing data received in accordance with a bit-synchronous HDLC format. By processing the data in parallel, eight bits at a time during a single clock cycle, the HDLC engine of the invention provides a method and system for processing bit-synchronous HDLC data which is significantly faster than previous bit-synchronous HDLC engines. Thus, the invention provides a bit-synchronous HDLC engine capable of handling greater bandwidths when compared to prior art engines. One of ordinary skill in the art will appreciate that the above description is exemplary only and that the invention may be practiced with modifications or variations of the techniques disclosed above. Those of ordinary skill in the art will know, or be able to ascertain using no more than routine experimentation, many equivalents to the specific embodiments of the invention described herein. Such equivalents are encompassed by the following claims.

What is claimed is:

1. A method of parallel processing bit-synchronous HDLC data, comprising:
storing at least two bytes of bit-synchronous HDLC data in a shift register, wherein, at each successive clock cycle, a new incoming byte is shifted into said shift register and an old byte is shifted out of said shift register;
processing in parallel a plurality of bits within said shift register so as to detect a SOF sequence during a first clock cycle;
processing in parallel a plurality of bits within said shift register so as to detect an EOF sequence during at least one subsequent clock cycle; and
sending valid payload data bits to a packer logic unit, wherein said valid payload data bits comprise at least some bits shifted into said shift register between said SOF sequence and said EOF sequence.

2. The method of claim 1 further comprising processing in parallel a plurality of bits within said shift register to detect an Abort sequence during said at least one subsequent clock cycle, wherein if said Abort sequence is detected, all bits received after said SOF sequence are discarded and a search for a new SOF sequence is initiated.

3. The method of claim 1 further comprising:
processing in parallel a plurality of bits within said shift register to detect at least one stuff bit; and
discarding said at least one stuff bit, if detected, wherein said valid payload data bits comprise all bits shifted into said shift register between said SOF sequence and said EOF sequence, excluding said at least one stuff bit.

4. The method of claim 1 further comprising discarding all bits received between said SOF and EOF sequences if an amount of valid payload data bits received constitute less than a minimum number (N) of bytes.

5. The method of claim 1 wherein said acts of processing in parallel comprise providing a plurality of comparators coupled to said shift register, wherein each comparator is coupled to said shift register so as to parallel process a unique combination of eight successive bits contained within said shift register.

6. A method of parallel processing bit-synchronous data, comprising:
storing at least two bytes of bit-synchronous data in a shift register, wherein a newly received byte is shifted in and an old byte is shifted out of said shift register at each clock cycle;
processing in parallel a plurality of bits within said shift register so as to detect valid payload data bits; and
storing detected valid payload data bits in a packer logic unit for further processing.

7. The method of claim 6 wherein said act of processing in parallel comprises searching for a specified sequence of bits stored within said shift register during a first clock cycle.

8. The method of claim 7 wherein said act of searching for a specified sequence comprises searching for a start sequence within said shift register, wherein said valid payload data bits comprise at least some bits received after said start sequence.

9. The method of claim 8 further comprising searching for an end sequence within said shift register, after said start sequence has been detected, during at least one clock cycle subsequent to said first clock cycle, wherein said valid payload data bits comprise at least some bits received between said start and end sequences.

10. The method of claim 9 wherein said bit-synchronous data comprises bit-synchronous HDLC data, said start sequence comprises a SOF sequence and said end sequence comprises an EOF sequence.

11. The method of claim 10 further comprising processing in parallel a plurality of bits stored in said shift register to detect an Abort sequence during at least one clock cycle subsequent to said first clock cycle, wherein if said Abort sequence is detected, all bits received after said SOF sequence are discarded and a search for a new SOF sequence is initiated.

12. The method of claim 10 further comprising:
processing in parallel a plurality of bits within said shift register to detect at least one stuff bit; and
discarding said at least one stuff bit, if detected, wherein said valid payload data bits comprise all bits shifted into said shift register between said SOF sequence and said EOF sequence, excluding said at least one stuff bit.

13. The method of claim 10 further comprising discarding all bits received between said SOF and EOF sequences if an amount of valid payload data bits received constitute less than a minimum number (N) of bytes.

14. The method of claim 6 wherein said act of processing in parallel comprises providing a plurality of comparators coupled to said shift register, wherein each comparator is coupled to said shift register so as to parallel process a unique combination of eight successive bits contained within said shift register.

15. The method of claim 6 further comprising de-scrambling said at least two bytes prior to storing said at least two bytes in said shift register, wherein said de-scrambling comprises de-scrambling at least eight bits in parallel during a single clock cycle.

16. A system for parallel processing bit-synchronous data, comprising:
a shift register for storing a plurality of bits of bit-synchronous data, wherein a new plurality of bits is shifted in and an old plurality of bits is shifted out of said shift register during successive clock cycles; and
a de-framer unit, coupled to said shift register, for detecting valid payload data, wherein said de-framer unit processes in parallel a plurality of bits within said shift register during a first clock cycle.

17. The system of claim 16 wherein said de-framing unit further processes in parallel said plurality of bits within said shift register to detect a specified sequence of bits during said first clock cycle.

18. The system of claim 17 wherein said de-framing unit searches for a start sequence within said shift register, wherein said valid payload data bits comprise at least some bits received after said start sequence.

19. The system of claim 18 wherein said de-framing unit further searches for an end sequence within said shift register, after said start sequence has been detected, during at least one clock cycle subsequent to said first clock cycle, wherein said valid payload data bits comprise at least some bits received between said start and end sequences.

20. The system of claim 16 wherein:
said bit-synchronous data comprises bit-synchronous HDLC data;
said shift register stores at least two bytes of said bit-synchronous HDLC data;
said new and old plurality of bits each comprise one byte of data;
said de-framer unit comprises a plurality of comparators wherein each comparator is coupled to a unique subset of eight successive bits contained within said shift register;
said start sequence comprises a SOF sequence;
said end sequence comprises an EOF sequence; and
said valid payload data bits comprise at least some bits received between said SOF and EOF sequences.

21. The system of claim 20 wherein said de-framer unit further processes in parallel a plurality of bits stored in said shift register to detect an Abort sequence during at least one clock cycle subsequent to said first clock cycle, wherein if said Abort sequence is detected, all bits received after said SOF sequence are discarded and a search for a new SOF sequence is initiated.

22. The system of claim 20 wherein said de-framer unit further processes in parallel a plurality of bits within said shift register to detect at least one stuff bit and discards said at least one stuff bit, if detected, wherein said valid payload data bits comprise all bits shifted into said shift register between said SOF sequence and said EOF sequence, excluding said at least one stuff bit.

23. The system of claim 20 further comprising a packer logic unit, coupled to said de-framer unit, for storing said valid payload data received from said de-framer unit, said de-framer unit further comprising a look-up table (LUT) representing a plurality of bit sequences containing at least one stuff bit and wherein, if said at least one stuff bit is detected, said LUT passes through valid payload data bits to said packer logic unit while not allowing said at least one stuff bit to be sent to said packer logic unit.

24. The system of claim 23 wherein said packer logic unit discards said valid payload data received from said de-framer unit if an amount of valid payload data bits received constitute less than a minimum number (N) of bytes.

25. A bit-synchronous HDLC engine, comprising:
a shift register for storing at least two bytes of bit-synchronous HDLC data, wherein a new byte is shifted in and an old byte is shifted out of said shift register during each successive clock cycle; and
a de-framer unit, coupled to said shift register, for detecting valid payload data within said shift register, wherein said de-framer unit comprises a plurality of comparators for detecting a specified sequence of bits within said shift register during a first clock cycle, wherein each comparator is coupled to a unique subset of eight successive bits contained within said shift register.

26. The bit-synchronous HDLC engine of claim 25 wherein said de-framer unit detects a SOF sequence during said first clock cycle and detects an EOF sequence during a subsequent clock cycle, wherein said valid payload data comprises at least some of the bits received between said SOF sequence and said EOF sequence.

27. The bit-synchronous HDLC engine of claim 26 wherein said de-framer unit further processes in parallel a plurality of bits stored in said shift register to detect an Abort sequence during at least one clock cycle subsequent to said first clock cycle, wherein if said Abort sequence is detected, all bits received after said SOF sequence are discarded and a search for a new SOF sequence is initiated.

28. The bit-synchronous HDLC engine of claim 26 wherein said de-framer unit further processes in parallel a plurality of bits within said shift register to detect at least one stuff bit and discards said at least one stuff bit, if detected, wherein said valid payload data bits comprise all bits shifted into said shift register between said SOF sequence and said EOF sequence, excluding said at least one stuff bit.

29. The bit-synchronous HDLC engine of claim 28 further comprising a packer logic unit, coupled to said de-framer unit, for storing said valid payload data received from said de-framer unit, wherein said de-framer unit further comprises a look-up table (LUT) representing a plurality of bit sequences containing at least one stuff bit, wherein, if a stuff bit is detected, said LUT passes through valid payload data bits while not allowing said at least one stuff bit to be sent to said packer logic unit.

30. The bit-synchronous HDLC engine of claim 26 further comprising a packer logic unit, coupled to said de-framer unit, for storing said valid payload data received from said de-framer unit, wherein said packer logic unit discards said valid payload data received from said de-framer unit if an amount of valid payload data bits received constitute less than a minimum number (N) of bytes.

31. A system for parallel processing bit-synchronous data, comprising:
means for storing a plurality of bits of bit-synchronous data, wherein a new plurality of bits is stored and an old plurality of bits is expelled out of said means for storing during successive clock cycles; and
de-framer means, coupled to said means for storing, for detecting valid payload data and for processing in parallel a plurality of bits within said means for storing during a first clock cycle.

32. The system of claim 31 further comprising means for processing in parallel said plurality of bits within said means for storing to detect a specified sequence of bits during said first clock cycle.

33. The system of claim 32 wherein said means for processing in parallel comprises meand for detecting a start sequence contained within said means for storing, wherein said valid payload data bits comprise at least some bits received after said start sequence.

34. The system of claim 33 wherein said means for processing in parallel further comprising means for detecting an end sequence within said means for storing, after said start sequence has been detected, during at least one clock cycle subsequent to said first clock cycle, wherein said valid payload data bits comprise at least some bits received between said start and end sequences.

35. The system of claim 34 further comprising means for detecting an Abort sequence contained within said means for storing, during at least one clock cycle subsequent to said first clock cycle, wherein if said Abort sequence is detected, all bits received after said start sequence are discarded and a search for a new start sequence is initiated.

36. The system of claim 34 further comprising means for detecting at least one stuff bit contained within said means for storing and for discarding said at least one stuff bit, if detected, wherein said valid payload data bits comprise all bits stored in said means for storing after said start sequence and before said end sequence, excluding said at least one stuff bit.
